(19) United States
(12) Patent Application Publication
(10) Pub. No.: US 2026/0307650 A1
(43) Pub. Date: Oct. 8, 2026

(54) VEHICLE CONTROL DEVICE

(71) Applicant: HITACHI ASTEMO, LTD., Hitachinaka-shi, Ibaraki (JP)

(72) Inventors: Keita NAKAZAWA, Tokyo (JP); Tetsuya YAMADA, Tokyo (JP); Masashi SEIMIYA, Tokyo (JP)

(73) Assignee: HITACHI ASTEMO, LTD., Hitachinaka-shi, Ibaraki (JP)

(21) Appl. No.: 18/996,663

(22) PCT Filed: Mar. 8, 2023
(86) PCT No.: PCT/JP2023/008872

§ 371 Date: Jan. 17, 2025

(30) Foreign Application Priority Data
Jul. 21, 2022 (JP) 2022-116603

(51) Int. Cl. B60W 30/095; G06V 10/24; G06V 20/58; G08G 1/16

(52) U.S. Cl. CPC B60W 30/0956; G06V 10/24; G06V 20/58; G08G 1/166; B60W 2420/403; B60W 2556/10; B60W 2556/40; B60W 2556/45

(57) ABSTRACT

A vehicle control device secures a control margin time for performing collision avoidance control. A device recognizes information of a two-wheeled vehicle stored when overtaking the two-wheeled vehicle, the recognition information of the two-wheeled vehicle in the past is read with a left turn of a host vehicle at an intersection as a trigger, to determine a possibility of collision with the host vehicle and calculate prediction recognition information, when the obstacle is actually detected at the left turn of the host vehicle, it is immediately confirmed by using the prediction recognition information calculated in advance that the detected obstacle is re-detection of a moving object recognized in the past, and avoidance control is performed. I It's possible to secure a control margin time for collision avoidance with an obstacle coming from the rear of the host vehicle at the left turn, and it is possible to prevent collision.

### TECHNICAL FIELD

The present invention relates to a vehicle control device.

### BACKGROUND ART

Conventionally, there have been proposed a vehicle control device and a vehicle control method that perform collision avoidance control for avoiding a collision between an object in front of a host vehicle and the host vehicle.

As a conventional vehicle control device, there is known a vehicle control device that determines a possibility of collision between an object and a host vehicle by using a detection result of the object in front of the host vehicle, and performs collision avoidance control for avoiding collision between the object in front of the host vehicle and the host vehicle in a case where it is determined that the possibility of collision between the object and the host vehicle is high.

In addition, in order to solve a problem that in a case where when the host vehicle turns right/left at an intersection, a detection region changes with a change in the direction of the host vehicle, and an object located in a blind spot enters the detection region, an operation timing of the collision avoidance control is delayed since the object and the host vehicle are located close to each other at the time point of the object being detected, there has been proposed a technique in which in a case where it is determined that the host vehicle turns right/left after it is determined that the host vehicle has overtaken the object, the operation timing of the collision avoidance control is advanced compared to a case where it is not determined that the host vehicle has overtaken the object, and a case where it is determined that the host vehicle does not turn right/left after it is determined that the host vehicle has overtaken the object (see PTL 1).

### CITATION LIST

### Patent Literature

PTL 1: Japanese U.S. Pat. No. 6,617,696

### SUMMARY OF INVENTION

### Technical Problem

Incidentally, in order to execute the avoidance control, usually, an object is detected by an external recognition sensor such as a camera sensor attached to a vehicle, tracking is performed for a certain period, and whether the object is an avoidance target is determined and specified. Then, the process follows the flow of performing the avoidance control on the avoidance target. Generally, in order to specify an object as an avoidance target, a tracking processing time of a certain period is required to prevent erroneous recognition.

In addition, a case will be considered in which when the host vehicle turns right/left at an intersection, the avoidance control is performed on an object (a bicycle, a two-wheeled vehicle, or the like) coming from a crossing direction or the rear. In the case of the avoidance control for the object coming from the crossing direction, a position where the avoidance control is started is away from the host vehicle, and thus it is easy to secure a control margin time for avoidance. On the other hand, in the case of the avoidance control for the object coming from the rear, the position where the avoidance control is started is close to the host vehicle, and thus it is difficult to secure the control margin time for avoidance. Actually, since the host vehicle also moves, it is more difficult to secure the control margin time for the avoidance control with respect to the object coming from the rear. As described above, whether or not the avoidance control is in time varies depending on a difference in a direction in which the object comes to the host vehicle (see FIG. 1).

Therefore, in a case where a moving obstacle with a high speed such as a bicycle comes to the vehicle from the rear, a time for confirming the moving obstacle as an avoidance target is similarly required, but even if a shift to the avoidance control is made after confirmation as the avoidance target, there is a high possibility that the moving obstacle cannot be avoided in time.

The collision avoidance control proposed by the method of PTL 1 is intended to respond to an object located in a blind spot by advancing the operation timing under an additional condition after determination as an avoidance target, but a time until determination as an avoidance target is not taken into consideration. Therefore, even if PTL 1 is applied, in a case where a moving object with a high speed such as a bicycle comes from the rear, a time for confirmation as an avoidance target is similarly required, and thus, there is a high possibility that the collision cannot be avoided even if the operation timing is advanced.

The present invention has been made in view of the above circumstances, and an object thereof is to provide a vehicle control device capable of securing a control margin time necessary for avoidance control and performing collision avoidance control.

### Solution to Problem

A vehicle control device according to the present invention includes: an external environment recognition unit that acquires external environment information at least in front of a host vehicle; a control unit that controls the host vehicle based on the external environment information acquired by the external environment recognition unit; and a storage unit that stores detection information of a moving object acquired by the external environment recognition unit when the host vehicle overtakes the moving object. The external environment recognition unit reads past detection information of the moving object stored in the storage unit when a course change of the host vehicle is predicted, determines a possibility of collision between the host vehicle and the moving object, sets, as prediction recognition information, a moving object having a high possibility of colliding with the host vehicle at the course change of the host vehicle, based on the possibility of the collision, and determines whether or not detection information of a moving object detected by the external environment recognition unit when the host vehicle changes a course is same as past detection information of the moving object included in the prediction recognition information.

### Advantageous Effects of Invention

According to the present invention, it is possible to secure a control margin time for the avoidance control, for example, with respect to an obstacle coming from the rear of a host vehicle at the time of right/left turn at an intersection and perform collision avoidance control.

According to the present invention, it is possible to realize prevention of, for example, a caught-in accident of a two-wheeled vehicle at the time of right/left turn at an intersection, which has been difficult to cope with conventionally.

Problems, configurations, and effects other than those described above will be clarified by the following description of embodiments.

### BRIEF DESCRIPTION OF DRAWINGS

FIG. 1 is a schematic view of a problem to be solved by the present invention.

FIG. 2 is a schematic view of an embodiment of the present invention.

FIG. 3 is a schematic block diagram of a vehicle control device according to the embodiment of the present invention.

FIG. 4 is an overall flowchart according to the embodiment of the present invention.

FIG. 5 is a flowchart regarding collision possibility determination in the embodiment of the present invention.

FIG. 6 is a flowchart regarding prediction region setting according to the embodiment of the present invention.

FIG. 7 is a flowchart regarding tracking processing reduction using prediction recognition information according to the embodiment of the present invention.

FIG. 8 is a flowchart regarding right/left turn determination in the embodiment of the present invention.

### DESCRIPTION OF EMBODIMENTS

Hereinafter, an embodiment of the present invention will be described with reference to the drawings.

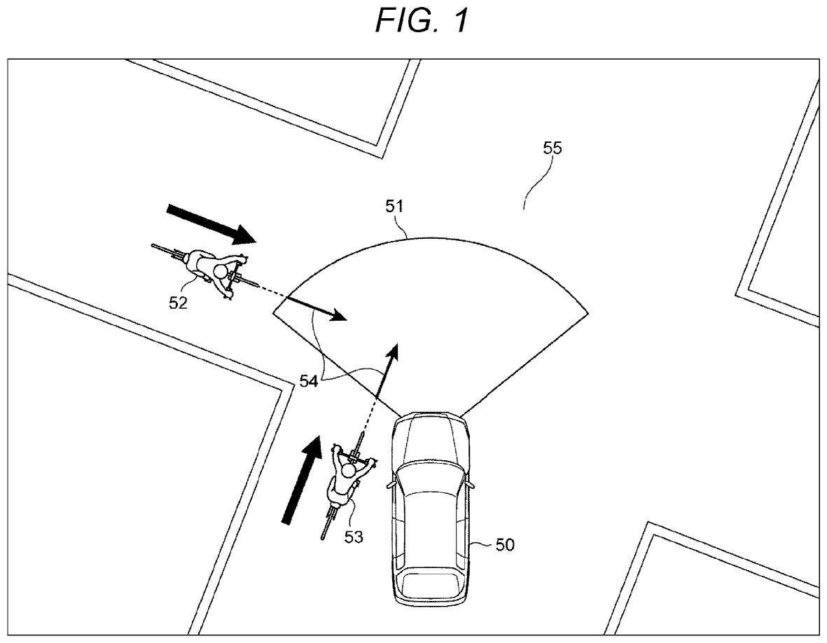

Prior to description of an embodiment of the present invention, problems to be solved by the present invention will be described with reference to FIG. 1. FIG. 1 illustrates a situation in which a vehicle turns left at an intersection, and includes a host vehicle 50 having an avoidance control function for traveling on a general road 55 having an intersection, a sensor detection region 51 used for the avoidance control function, a period 54 necessary for specifying an avoidance target when avoidance control is performed, a bicycle 53 coming to the host vehicle 50 from the rear, and a bicycle 52 coming to the host vehicle 50 from a crossing direction.

A case will be considered in which the avoidance control is performed on each of the bicycle 52 coming from the crossing direction and the bicycle 53 coming from the rear when the host vehicle 50 turns left at an intersection. The avoidance control function prevents collision by actually performing the avoidance control after an obstacle is detected in the sensor detection region 51 and specified as an avoidance target.

First, in the case of the avoidance control for the bicycle 52 coming from the crossing direction, the avoidance control is actually started after the period 54 in which the bicycle 52 enters the sensor detection region 51 and is specified as the avoidance target, but a control margin time for avoidance can be secured since a position where the avoidance control is started is away from the host vehicle 50.

On the other hand, in the case of the avoidance control for the bicycle 53 coming from the rear, the avoidance control is actually started after the period 54 in which the bicycle 53 enters the sensor detection region 51 and is specified as the avoidance target, and the control margin time for avoidance cannot be secured since the position where the avoidance control is started is close to the host vehicle 50. Actually, since the host vehicle 50 also moves, it is more difficult to secure the control margin time for the avoidance control with respect to the obstacle coming from the rear.

As described above, whether or not the avoidance control is in time varies depending on a difference in a direction in which the bicycles 52 and 53 come to the host vehicle 50. Even in a case where the above-described conventional technique (PTL 1) is applied to such a problem, it is difficult to cope with the case of the bicycle 53 coming from the rear since the period 54 for specifying the avoidance target is not clearly described.

In addition, the idea that it is sufficient that the avoidance control is started simply at a stage of entering the sensor detection region 51 is problematic from the viewpoint of preventing a malfunction, and it is not realistic to simply shorten the period 54 for specifying the detected object as the avoidance target.

In the present invention, the problem is how to shorten a period for specifying, as an avoidance target for which avoidance control is performed, an obstacle coming from the rear as well as an obstacle coming from the crossing direction or from the front while preventing a malfunction.

In the embodiment of the present invention, with respect to the present problem, a means and a device are provided which have three operations: (1) an operation in which recognition information of a moving object such as a bicycle is stored when overtaking the moving object at the time of traveling in front of an intersection, so that when the host vehicle is predicted to turn left at the intersection, the recognition information stored in the past is read to determine a possibility of collision between the host vehicle and the moving object stored in the past; (2) an operation in which the information of the moving object specified as having a high collision possibility as a result of determining the possibility of collision is used to calculate, as prediction recognition information, a detection timing and a detection region in which the moving object is predicted to be detected in the sensor detection range of the host vehicle when the host vehicle turns left, and a region in which the moving object is predicted to be detected is set in the sensor detection region at least in front of the host vehicle; and (3) an operation in which in a case where the object is detected at the predicted detection timing or in the detection region when the host vehicle turns left at the intersection, it is determined that the moving object stored in the past is re-detected, so as to shorten a period for specifying an avoidance target for which avoidance control is performed, thereby securing a control margin time necessary for the avoidance control.

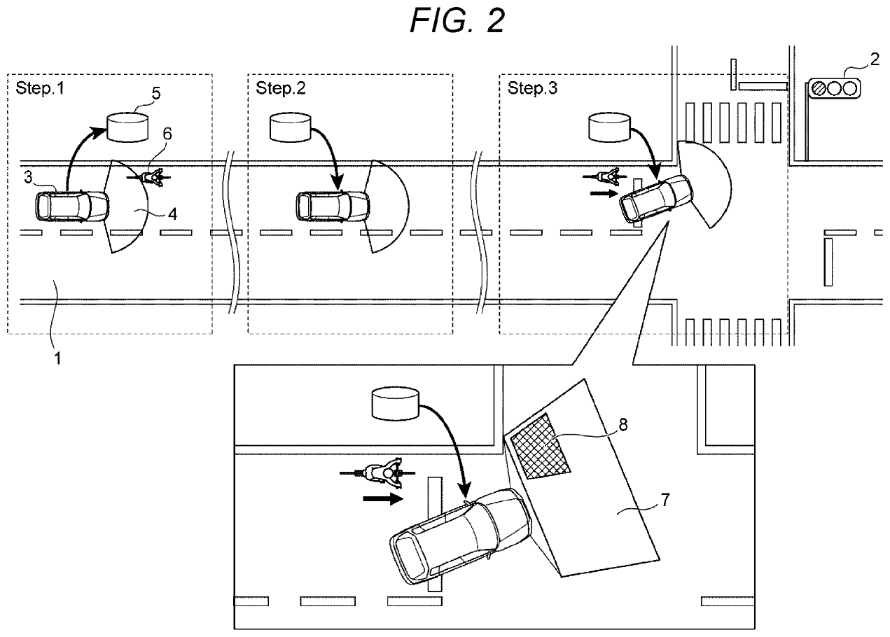

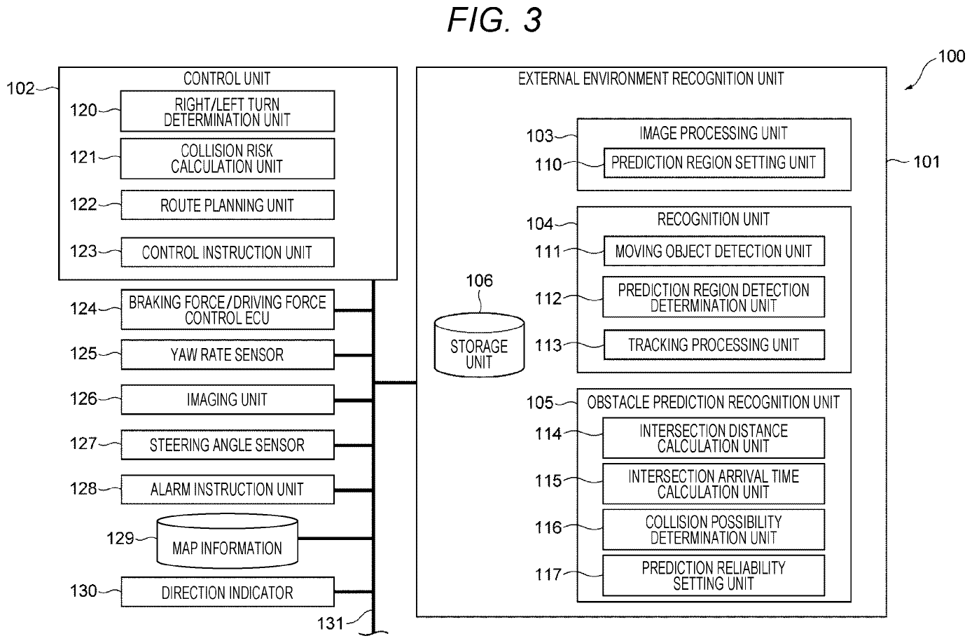

First, a basic concept of the present proposal will be described with reference to FIG. 2. A vehicle control device 100 (FIG. 3) of the present embodiment is mounted on a host vehicle 3, and performs collision avoidance control for avoiding a collision between an object in front of the host vehicle and the host vehicle. In the present embodiment, it is assumed that the collision avoidance control is performed on a general road 1 including a traffic light 2 and an intersection.

FIG. 2 is a conceptual view in a case where the collision avoidance control is performed with respect to a two-wheeled vehicle 6 traveling from the rear when the host vehicle 3 turns left at the intersection, and the operation will be described separately in Step 1, Step 2, and Step 3 indicating the operation flow of the present embodiment.

Among the three operations of the embodiment of the present invention, description using Steps 1 and 2 will be given about (1) the operation in which recognition information of a moving object such as a bicycle is stored when overtaking the moving object at the time of traveling in front of an intersection, so that when the host vehicle is predicted to turn left at the intersection, the recognition information stored in the past is read to determine a possibility of collision between the host vehicle and the moving object stored in the past.

First, as in Step 1 of FIG. 2, the host vehicle 3 and the two-wheeled vehicle 6 are traveling on the general road 1. When the two-wheeled vehicle 6 is detected in the sensor detection region 4 of the host vehicle 3, a speed, a relative position to the host vehicle, a detection time, and the like are acquired as the recognition information of the two-wheeled vehicle 6, and when the host vehicle 3 overtakes the two-wheeled vehicle 6 and the two-wheeled vehicle 6 deviates from the sensor detection region 4, the information is stored in a storage unit 5 as reusable information.

Next, as in Step 2, a traveling route of the host vehicle 3 is acquired from map information such as a navigation system, and it is determined whether there is a possibility that the host vehicle 3 passes through the intersection. When it is determined that the host vehicle 3 passes through the intersection, the recognition information of the two-wheeled vehicle 6 stored in the storage unit 5 is read, and the possibility of collision at the time of left turn at the intersection between the two-wheeled vehicle 6 and the host vehicle 3 is determined from the read past recognition information. Specifically, a distance of the host vehicle 3 to the intersection is obtained, and an intersection arrival time is calculated. Next, the intersection arrival time of the two-wheeled vehicle 6 is calculated from the recognition information of the two-wheeled vehicle 6 read from the storage unit 5 on the assumption that the two-wheeled vehicle 6 performs a uniform linear motion from the detection time point. The calculated intersection arrival times of the host vehicle 3 and the two-wheeled vehicle 6 are compared, and the possibility that the two-wheeled vehicle 6 comes from the rear at a timing when the host vehicle 3 turns left at the intersection is determined as a collision possibility. In a case where it is determined that the collision possibility is high, the recognition information (past recognition information) stored in the storage unit 5 as the prediction recognition information is specified as an obstacle which is highly likely to be re-detected at the time of turning left at the intersection. Accordingly, it is possible to store the recognition information of a moving object such as a bicycle when overtaking the moving object at the time of traveling in front of the intersection, read the recognition information stored in the past when the host vehicle is predicted to turn left at the intersection, and determine the possibility of collision between the host vehicle and the moving object stored in the past.

Subsequently, description using Step 3 will be given about remaining two operations: (2) the operation in which the information of the moving object specified as having a high collision possibility as a result of determining the possibility of collision is used to calculate, as prediction recognition information, a detection timing and a detection region in which the moving object is predicted to be detected in the sensor detection range of the host vehicle when the host vehicle turns left, and a region in which the moving object is predicted to be detected is set in the sensor detection region at least in front of the host vehicle, and (3) the operation in which in a case where the object is detected at the predicted detection timing or in the detection region when the host vehicle turns left at the intersection, it is determined that the moving object stored in the past is re-detected, so as to shorten a period for specifying an avoidance target for which avoidance control is performed, thereby securing a control margin time necessary for the avoidance control.

Step 3 is a situation in which the two-wheeled vehicle 6 comes from the rear at a timing when the host vehicle 3 actually turns left at the intersection. Whether the host vehicle 3 turns left at the intersection is determined based on control information of a direction indicator or the like. With the left turn of the host vehicle 3 at the intersection as a trigger, it is determined whether or not the prediction recognition information calculated in Step 2 exists. In a case where the prediction recognition information exists, an obstacle detection timing (also referred to as a predicted detection timing) and a detection region (also referred to as a predicted detection region) at the time of turning left at the intersection are predicted from the prediction recognition information, and a prediction region 8 corresponding to the predicted detection region is set for an image 7 generated by an image processing unit. Accordingly, a detection timing and a detection region in which the moving object is predicted to be detected in the sensor detection range of the host vehicle when the host vehicle turns left can be calculated as the prediction recognition information by using the information of the moving object specified as having a high collision possibility, and a region in which the moving object is predicted to be detected can be set in the sensor detection region at least in front of the host vehicle.

If an object is detected in the sensor detection region 4 when the host vehicle 3 turns left at the intersection, whether or not the obstacle is predicted in advance can be determined immediately by performing condition determination together with the prediction recognition information, and a shift to the avoidance control (or alarm) can be made with a shortened period necessary for normal collision avoidance control and necessary for specifying an avoidance target. Specifically, if an object is detected in the sensor detection region 4, whether the object is the stored two-wheeled vehicle 6 is immediately specified based on conditions such as whether or not the detected timing coincides with the predicted timing or whether or not the detection position is detected in the prediction region 8 (corresponding to the predicted detection region), so as to shorten the time necessary for specifying the avoidance target in the collision avoidance control.

According to the present proposal, the time necessary until executing the collision avoidance control, that is, the time for detecting the object, recognizing the object for a certain period of time, and specifying the avoidance target, which is difficult to simply shorten, can be shortened by adding the prediction recognition information. By shortening the time, a timing of starting the avoidance control can be advanced, so that it is possible to secure a control margin time for avoiding the obstacle.

FIG. 3 illustrates a configuration diagram of the vehicle control device according to the embodiment of the present invention. The vehicle control device 100 of the present embodiment is a vehicle control device that includes an external environment recognition unit 101 that performs obstacle recognition and traffic light recognition, a control unit 102 that actually instructs avoidance control, and a storage unit 106 that stores (saves) recognition information by the external environment recognition unit 101, and implements collision avoidance control.

The external environment recognition unit 101 acquires external environment information in front of the host vehicle, and includes an image processing unit 103 for generating an image to be used in recognition processing, a recognition unit 104 that performs detection of a vehicle or a lane, time-series tracking of a detection target, and the like, and an obstacle prediction recognition unit 105 that determines a possibility of collision when the host vehicle turns left at an intersection, based on past recognition information stored in the storage unit 106 that stores the information recognized by the recognition unit 104, and generates prediction recognition information.

The obstacle prediction recognition unit 105 includes: an intersection distance calculation unit 114 that acquires map information 129 from an MPU which has high-precision map information such as intersection width information, data on road structures such as intersection stop line positions and the number of lanes, and three-dimensional road object information such as road signs and traffic light positions, a global navigation satellite system (GNSS) which acquires position information of a host vehicle via a positioning satellite, or the like, and calculates a distance from the host vehicle to an intersection; an intersection arrival time calculation unit 115 that calculates an intersection arrival time when an obstacle travels to the intersection with uniform linear motion and an intersection arrival time when the host vehicle arrives at the intersection, based on obstacle information (past recognition information) stored in the storage unit 106; a collision possibility determination unit 116 that determines a collision possibility based on a comparison in the intersection arrival time calculated by the intersection arrival time calculation unit 115 between the obstacle and the host vehicle and calculates prediction recognition information; and a prediction reliability setting unit 117 that adds reliability to the prediction recognition information calculated by the collision possibility determination unit 116, based on an elapsed time after detection of the obstacle, an external factor that lowers detection accuracy such as a weather condition at the time of the detection, and the like. Note that the reliability set by the prediction reliability setting unit 117 is used to determine the possibility that the obstacle detected by the prediction region detection determination unit 112 described later (when the host vehicle turns left at the intersection) is an obstacle detected in the past and stored in the storage unit 106 (determination of coincidence or identity between detection information of the obstacle and past detection information).

The recognition unit 104 includes a moving object detection unit 111 that identifies a moving object, such as a two-wheeled vehicle, traveling on a general road, the prediction region detection determination unit 112, and a tracking processing unit 113. The prediction region detection determination unit 112 receives the prediction recognition information from the obstacle prediction recognition unit 105, calculates a region (prediction region) in which detection of an obstacle included in the prediction recognition information is predicted in an image captured by an imaging unit 126, and passes the prediction region information to a prediction region setting unit 110 of the image processing unit 103. The prediction region setting unit 110 sets a prediction region for the image captured by the imaging unit 126 (specifically, at least a part of the image) (see FIG. 2). When the moving object is actually detected by the moving object detection unit 111, the prediction region detection determination unit 112 determines whether or not the moving object is detected in the prediction region. The prediction region detection determination unit 112 determines a possibility that the detected obstacle is an obstacle detected in the past, based on a condition of whether or not the moving object has been detected in the prediction region and a condition of whether or not a time when the moving object has been detected is a predicted time, and gives the possibility to the tracking processing unit 113. In other words, the prediction region detection determination unit 112 determines whether or not the detection information of the detected moving object is the same as past detection information of the moving object, based on conditions of the predicted detection timing and the predicted detection region, and passes the result to the tracking processing unit 113. The tracking processing unit 113 normally performs detection of a vehicle or a lane, time-series tracking of a detection target, and the like, but in the case of the collision avoidance control of the present embodiment, in order to specify an obstacle as an avoidance target for which the avoidance control is performed, it is necessary to perform tracking processing for a certain period after detecting an obstacle for a first time and determine whether or not the obstacle is an obstacle having a collision possibility. In addition to the normal tracking processing, in a case where the prediction recognition information indicating that the detected obstacle is likely to be an obstacle detected in the past is passed (in other words, in a case where it is determined that the detection information of the detected moving object is the same as the past detection information of the moving object included in the prediction recognition information), the tracking processing unit 113 of the present embodiment can shorten the tracking processing time for specifying the detected obstacle as the avoidance target by adding information recognized in advance as compared with the normal tracking processing. Accordingly, it is possible to shorten the period for specifying the avoidance target for which the collision avoidance control is performed.

The control unit 102 controls the host vehicle on the basis of the external environment information acquired by the external environment recognition unit 101, and includes a right/left turn determination unit 120, a collision risk calculation unit 121, a route planning unit 122, and a control instruction unit 123. The right/left turn determination unit 120 determines whether or not the host vehicle is in a right/left turning state, based on information of a yaw rate sensor 125, a steering angle sensor 127, and a direction indicator 130. The collision risk calculation unit 121 calculates a time to collision (TTC) with respect to the obstacle having a high collision possibility determined by the external environment recognition unit 101 (in other words, specified as the avoidance target of the avoidance control), determines a collision risk, and determines necessity of execution of the avoidance control. The route planning unit 122 calculates a travel route for performing collision avoidance. The control instruction unit 123 calculates a control value of the collision avoidance control and instructs a braking force/driving force control ECU 124.

The braking force/driving force control ECU 124 issues an appropriate control instruction to each actuator of the vehicle according to the control instruction value of the control instruction unit 123.

An alarm instruction unit 128 has a role of issuing an alarm to a driver that the risk of collision is imminent or notifying the driver that the avoidance control is in progress through displays or audible signals during the collision avoidance control, based on the information of the collision risk calculation unit 121 or the like. In addition, the above-described configurations are connected to each other by a communication network 131.

In the present embodiment, the external environment recognition unit 101 is exemplified by an imaging unit (camera sensor) that is mounted on a vehicle front side and images at least the front of the host vehicle as a means for acquiring external environment information of at least the front of the host vehicle. However, the present invention can be applied not only to a single camera sensor but also to a combination of a camera sensor and a radar sensor or a combination of other sensors.

The external environment recognition unit 101 and the control unit 102 operate independently in the present embodiment, but the present invention can be also applied to a configuration in which the external environment recognition unit 101 and the control unit 102 are integrated.

The obstacle prediction recognition unit 105 acquires the detection information from the storage unit 106 at the time of performing the collision possibility determination. However, in order to reduce a calculation load of data, the obstacle prediction recognition unit 105 may perform filtering regarding whether or not the obstacle is a two-wheeled vehicle, based on width information of the detected obstacle included in the detection information, so as to limit data to be acquired.

The storage unit 106 may be shared with a normal storage unit used in the external environment recognition unit 101, or may be independently arranged as a dedicated storage unit in the present embodiment.

The number of prediction regions set by the prediction region setting unit 110 is not limited to one, and a plurality of prediction regions may be set. At that time, a method of setting the prediction region may be changed according to the reliability included in the prediction recognition information.

In the prediction region set by the prediction region setting unit 110, in a case where setting information is not detected even after a predicted detection time has passed from the detection timing included in the prediction recognition information, the setting information can be deleted from the storage unit 106. In other words, in a case where the moving object included in the prediction recognition information is not detected even after the detection timing predicted for the prediction region set by the prediction region setting unit 110, the prediction recognition information can be deleted from the storage unit 106.

As an example of determining the collision possibility by the collision possibility determination unit 116, a method of simply obtaining the collision possibility based on the comparison of the intersection arrival times of the host vehicle 3 and the two-wheeled vehicle 6 has been described. However, the method of determining the collision possibility is not limited to this, and a method of improving the determination accuracy of the collision possibility such as predicting the future path of the two-wheeled vehicle 6 to determine the collision possibility is not limited in the present embodiment.

Since the time when the host vehicle 3 arrives at the intersection is changed by the control of the driver until the host vehicle 3 arrives at the intersection after the determination of the collision possibility by the collision possibility determination unit 116, the collision possibility determination may be performed as needed (in cycle time) until the host vehicle 3 arrives at the intersection.

The right/left turn determination unit 120 may acquire a steering angle control value and determine a right/left turn.

In the present embodiment, the intersection distance calculation by the intersection distance calculation unit 114 is calculated based on the information of the map information 129, but may be calculated based on a recognition result of a sensor (a camera sensor or the like) attached to the host vehicle, or may be calculated based on road-to-vehicle communication information received from a roadside communicator. In other words, as for a trigger for calculating the intersection distance and reading the obstacle information (past detection information) from the storage unit 106, the past detection information may be read when the travel route of the host vehicle is calculated based on the map information 129, and it is determined that the possibility of turning right/left at the intersection is high, the past detection information may be read when it is determined based on the intersection recognition result by the external environment recognition unit 101 that the possibility of turning right/left at the intersection is high, or the past detection information may be read when the intersection information acquired by the road-to-vehicle communication is used, and it is determined that the possibility of turning right/left at the intersection is high.

In the present embodiment, an example has been described in which the collision avoidance control is performed with respect to the obstacle coming from the rear when the host vehicle turns left. However, the present invention is not limited to the case of turning left, and can be applied to general course changes such as turning right.

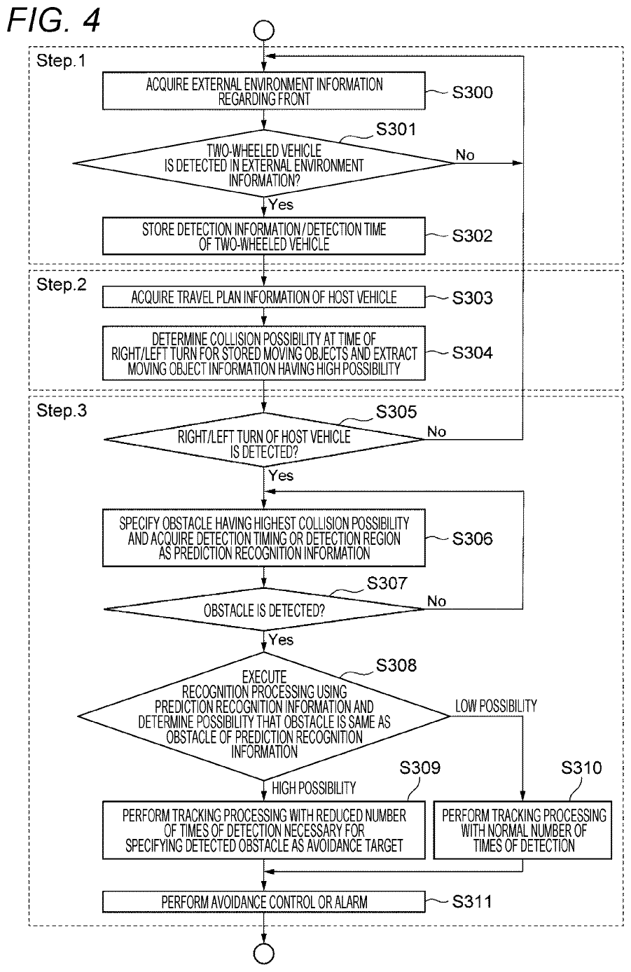

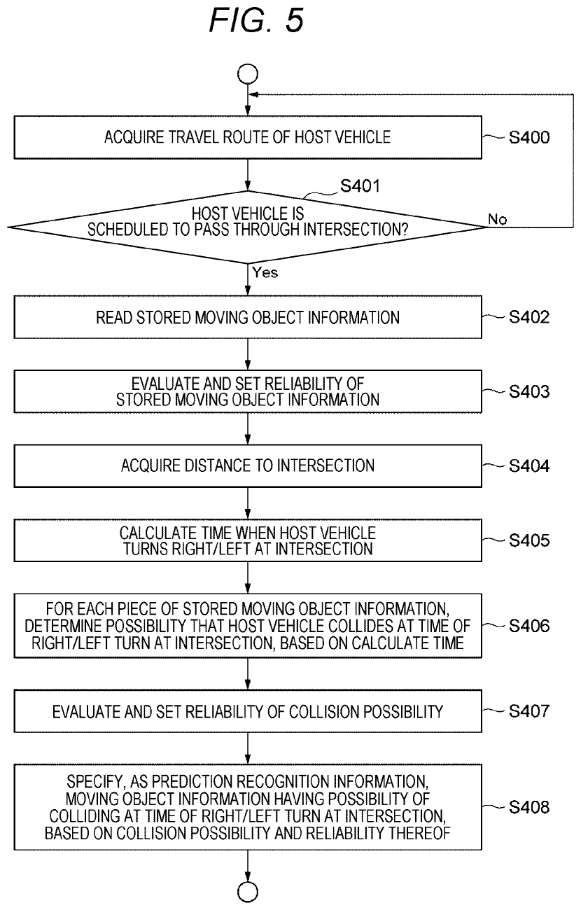

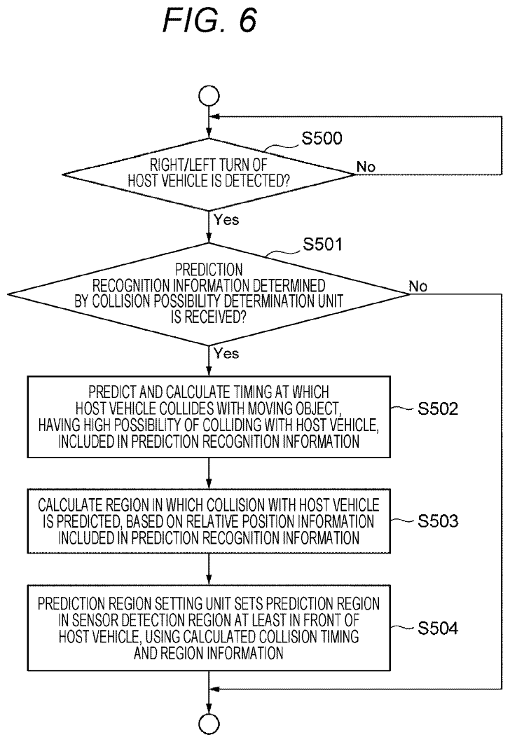

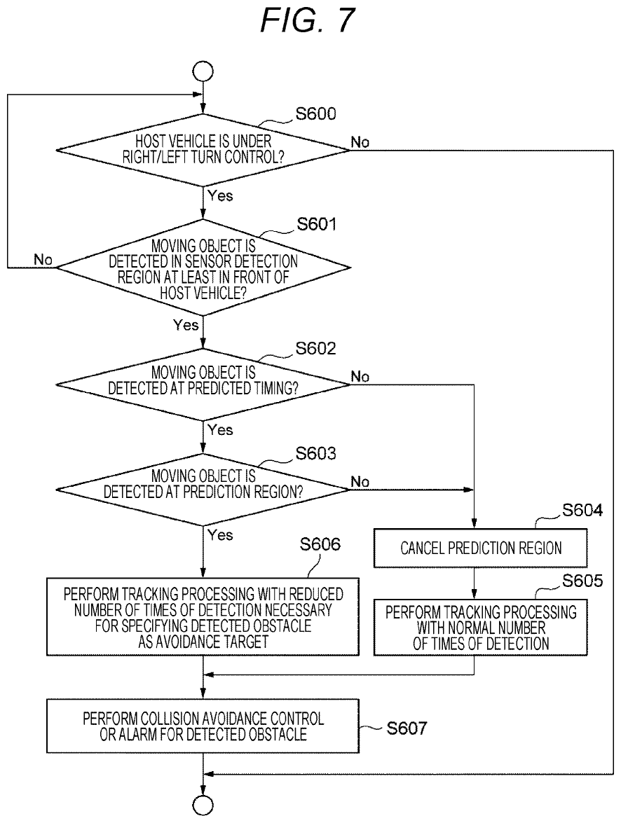

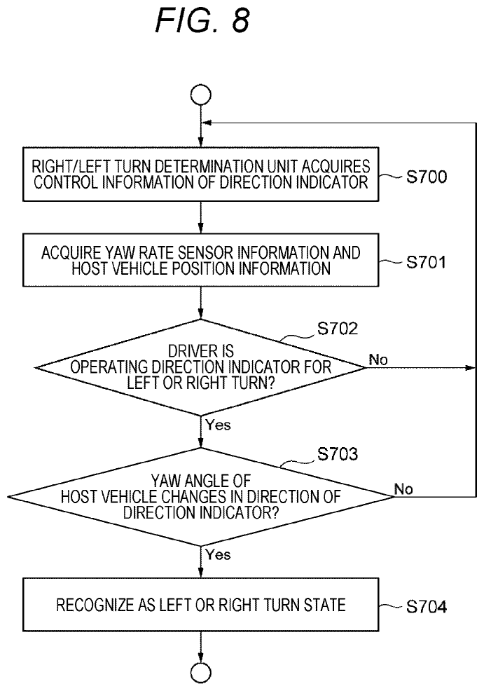

Based on the above configuration, an overall flow of the present embodiment is described with reference to a flowchart of FIG. 4, (1) the operation in which recognition information of a moving object such as a bicycle is stored when overtaking the moving object at the time of traveling in front of an intersection, so that when the host vehicle is predicted to turn left at the intersection, the recognition information stored in the past is read to determine a possibility of collision between the host vehicle and the moving object stored in the past is described with reference to a flowchart of FIG. 5, (2) the operation in which the information of the moving object specified as having a high collision possibility as a result of determining the possibility of collision is used to calculate, as prediction recognition information, a detection timing and a detection region in which the moving object is predicted to be detected in the sensor detection range of the host vehicle when the host vehicle turns left, and a region in which the moving object is predicted to be detected is set in the sensor detection region at least in front of the host vehicle is described with reference to a flowchart of FIG. 6, (3) the operation in which in a case where the object is detected at the predicted detection timing or in the detection region when the host vehicle turns left at the intersection, it is determined that the moving object stored in the past is re-detected, so as to shorten a period for specifying an avoidance target for which avoidance control is performed, thereby securing a control margin time necessary for the avoidance control is described with reference to a flowchart of FIG. 7, and a method of left turn determination of the host vehicle by the right/left turn determination unit 120 is described with reference to a flowchart of FIG. 8.

First, the flowchart of FIG. 4 will be described. Note that Steps 1 to 3 in FIG. 4 correspond to Steps 1 to 3 in FIG. 2.

First, the external environment recognition unit 101 attached to the host vehicle acquires external environment information regarding the front of the host vehicle (S300). It is determined whether a two-wheeled vehicle is included in the acquired external environment information (S301). In the case of No, the process returns to $300, and in the case of Yes, the process proceeds to S302. The detection information or the detection time of the two-wheeled vehicle recognized by the recognition unit 104 are stored in the storage unit 106 (S302).

The obstacle prediction recognition unit 105 acquires the travel plan information of the host vehicle from the map information 129, the position information of the host vehicle, and the like (S303). For the moving object information in the obstacle information (past recognition information) stored in the storage unit 106, the obstacle prediction recognition unit 105 determines a collision possibility when the host vehicle turns right/left, and extracts the obstacle determined to have a high collision possibility (S304).

Thereafter, the right/left turn determination unit 120 determines whether the host vehicle turns right/left (S305). In the case of No, the process returns to S300, and in the case of Yes, the process proceeds to S306. A moving object having a high collision possibility when the host vehicle turns right/left is specified, and a detection timing (predicted detection timing) or a detection region (predicted detection region) in which the moving object is predicted to be detected in the detection region of the host vehicle at the right/left turn is acquired as prediction recognition information (S306). It is determined whether or not the obstacle has been detected in the detection region of the host vehicle (S307). In the case of No, the process returns to S306, and in the case of Yes, the process proceeds to S308. Using the prediction recognition information acquired in S306, the detection timing and the detection region actually detected in S307 are compared with the prediction recognition information, and a possibility that the obstacle actually detected in S307 is the same as the obstacle specified in the prediction recognition information is determined (S308). In other words, it is determined whether or not the detection information of the moving object actually detected in S307 when the host vehicle turns right/left is the same as the past detection information of the moving object included in the prediction recognition information. In a case where it is determined that the possibility is high, the process proceeds to S309, and in a case where it is determined that the possibility is low, the process proceeds to S310. In a case where it is determined that the possibility that the obstacle re-detected in S308 is the same as the prediction recognition information detected in the past is high, the period (the number of times of detection), which is necessary for the normal collision avoidance control, for specifying the obstacle as the avoidance target is reduced, and it is immediately confirmed that the obstacle in the prediction recognition information is detected (S309). In a case where it is determined that the possibility that the obstacle re-detected in S308 is the same as the prediction recognition information detected in the past is low, as in the normal collision avoidance control, tracking processing is performed for a certain period (that is, at the normal number of times of detection) for specifying the obstacle as the avoidance target, and the obstacle is specified as the avoidance target (S310). The avoidance control is performed or an alarm is issued with respect to the avoidance target specified in the previous procedure (S311).

Subsequently, in (1) the operation in which recognition information of a moving object such as a bicycle is stored when overtaking the moving object at the time of traveling in front of an intersection, so that when the host vehicle is predicted to turn left at the intersection, the recognition information stored in the past is read to determine a possibility of collision between the host vehicle and the moving object stored in the past, description with reference to FIG. 5 will be given about the operation in which the recognition information stored in the past is read to determine a possibility of collision between the host vehicle and the moving object stored in the past.

The obstacle prediction recognition unit 105 acquires the travel plan information of the host vehicle from the map information 129, the position information of the host vehicle, and the like (S400). The obstacle prediction recognition unit 105 determines whether or not the host vehicle is scheduled to pass through the intersection, based on the map information 129, the position information of the host vehicle, and the like (S401). In the case of No, the process returns to S400, and in the case of Yes, the process proceeds to S402. The moving object information is read out from the past recognition information stored in the storage unit 106 (S402). The prediction reliability setting unit 117 calculates a reliability with respect to the moving object information read from the storage unit 106, based on the time when the moving object is detected, the detection accuracy, and the like and adds the reliability (S403). The intersection distance calculation unit 114 calculates a distance to the intersection, based on the current location of the host vehicle and the information of the map information 129 (S404). The intersection arrival time calculation unit 115 calculates an intersection arrival time when the host vehicle is predicted to arrive at the intersection and turn right/left, based on the intersection distance information calculated in S404 (S405). The collision possibility determination unit 116 calculates an intersection right/left turning time (intersection arrival time) with respect to each piece of the moving object information read in S402, and for each piece of the moving object information, determines a collision possibility with respect to each piece of the moving object information when the host vehicle turns right/left (S406). The prediction reliability setting unit 117 evaluates and sets a reliability with respect to the determined collision possibility (S407). The moving object information having a high possibility of colliding when the host vehicle turns right/left at the intersection is specified based on the collision possibility evaluated in S406 and the reliability evaluated in S407, and is passed as prediction recognition information to the recognition unit 104 (S408).

Description with reference to FIG. 6 will be given about (2) the operation in which the information of the moving object specified as having a high collision possibility as a result of determining the possibility of collision is used to calculate, as prediction recognition information, a detection timing and a detection region in which the moving object is predicted to be detected in the sensor detection range of the host vehicle when the host vehicle turns left, and a region in which the moving object is predicted to be detected is set in the sensor detection region at least in front of the host vehicle.

First, the right/left turn determination unit 120 detects that the host vehicle turns right/left (S500). In the case of No, the process returns to S500, and in the case of Yes, the process proceeds to S501. The recognition unit 104 determines whether or not the prediction recognition information described with reference to FIG. 5 (determined by the collision possibility determination unit 116) has been received from the obstacle prediction recognition unit 105 (S501). In the case of No, the process ends, and in the case of Yes, the process proceeds to S502. The recognition unit 104 calculates and predicts a timing at which the host vehicle collides with the moving object, which has a high possibility of colliding when the host vehicle turns right/left, included in the received prediction recognition information (S502). In addition, the recognition unit 104 calculates a sensor detection region predicted to be detected when the host vehicle turns right/left, based on the relative position information of the moving object to the host vehicle included in the prediction recognition information (S503). The prediction region setting unit 110 of the image processing unit 103 sets the sensor detection region as the prediction region (see FIG. 2) in (at least a part of) the sensor detection region at least in front of the host vehicle, based on the prediction recognition information including the calculated collision timing and the sensor detection region information (S504).

Description with reference to FIG. 7 will be given about (3) the operation in which in a case where the object is detected at the predicted detection timing or in the detection region when the host vehicle turns left at the intersection, it is determined that the moving object stored in the past is re-detected, so as to shorten a period for specifying an avoidance target for which avoidance control is performed, thereby securing a control margin time necessary for the avoidance control.

The right/left turn determination unit 120 determines whether or not the host vehicle is under right/left turn control (S600). In the case of No, the process ends, and in the case of Yes, the process proceeds to S601. The recognition unit 104 determines whether or not a moving object is detected in the sensor detection region at least in front of the host vehicle (S601). In the case of No, the process returns to S600, and in the case of Yes, the process proceeds to S602. For the moving object detected in S601, the prediction region detection determination unit 112 of the recognition unit 104 compares the collision timing included in the prediction recognition information calculated by the operation of FIG. 6 with the timing when the moving object is actually detected (S602). In other words, it is determined whether or not the moving object is detected at the predicted collision timing. In the case of No, the process proceeds to S604, and in the case of Yes, the process proceeds to S603. In addition, the prediction region detection determination unit 112 determines whether the moving object detected in S601 is detected in the prediction region set by the operation of FIG. 6 (S603). In other words, it is determined whether or not the moving object has been detected in the prediction region. In the case of No, the process proceeds to S604, and in the case of Yes, the process proceeds to S606. That is, it is determined whether or not the detection information of the moving object detected in S601 when the host vehicle turns right/left is the same as the past detection information of the moving object included in the prediction recognition information, based on conditions of the predicted detection timing and the predicted detection region.

In S604, the prediction region detection determination unit 112 determines that the possibility that the moving object detected in S601 is the same as the moving object which is included in the prediction recognition information and has been recognized in the past and determined to have a high collision possibility is low, and cancels the setting of the prediction region set in FIG. 6 (S604). Then, the tracking processing performed in the normal collision avoidance control is performed (S605).

In the case of Yes in S603, the prediction region detection determination unit 112 determines that the possibility that the moving object detected in S601 is the same as the moving object which is included in the prediction recognition information and has recognized in the past and determined to have a high collision possibility is high. That is, it is determined that the detection information of the moving object detected in S601 when the host vehicle turns right/left is the same as the past detection information of the moving object included in the prediction recognition information. In this case, the tracking processing is performed only on the moving object detected in the prediction region, the avoidance target can be specified with the number of times of detection (tracking processing time) necessary for the tracking processing reduced by using the prediction recognition information, and the tracking processing method can be simplified while the detection accuracy is maintained. As a result, the period necessary for the normal collision avoidance control and necessary for specifying the avoidance target can be shortened (S606). The control unit 102 performs collision avoidance control or an alarm with respect to the avoidance target specified by the recognition processing in S605 or S606 (S607).

Finally, how the right/left turn determination unit 120 of the control unit 102 determines the right/left turn of the host vehicle will be described with reference to FIG. 8.

The right/left turn determination unit 120 acquires control information of the direction indicator 130 (S700). The right/left turn determination unit 120 acquires information of the host vehicle position from the information of the yaw rate sensor 125, the map information 129, and the like (S701). It is determined based on the information acquired in S700 whether or not the direction indicator is operated for left/right turn (S702). It is determined based on the yaw rate sensor information acquired in S701 whether or not the host vehicle changes in the same direction as the indicated direction of the direction indicator (S703). When the determination results in S702 and S703 are Yes, the right/left turn determination unit 120 determines that the vehicle is in a left/right turn state (S704).

In the present embodiment, with the above three methods which are (1) the operation in which recognition information of a moving object such as a bicycle is stored when overtaking the moving object at the time of traveling in front of an intersection, so that when the host vehicle is predicted to turn left at the intersection, the recognition information stored in the past is read to determine a possibility of collision between the host vehicle and the moving object stored in the past, (2) the operation in which the information of the moving object specified as having a high collision possibility as a result of determining the possibility of collision is used to calculate, as prediction recognition information, a detection timing and a detection region in which the moving object is predicted to be detected in the sensor detection range of the host vehicle when the host vehicle turns left, and a region in which the moving object is predicted to be detected is set in the sensor detection region at least in front of the host vehicle, and (3) the operation in which in a case where the object is detected at the predicted detection timing or in the detection region when the host vehicle turns left at the intersection, it is determined that the moving object stored in the past is re-detected, so as to shorten a period for specifying an avoidance target for which avoidance control is performed, thereby securing a control margin time necessary for the avoidance control, the period necessary until executing the collision avoidance control, that is, the period for detecting the object, recognizing the object for a certain period of time, and specifying the avoidance target, which is difficult to simply shorten, can be shortened by adding the prediction recognition information. By shortening the period, a timing of starting the avoidance control from the first detection of the obstacle can be advanced, so that it is possible to secure a control margin time for avoiding the obstacle.

As for the securing of the control margin time of the avoidance control with respect to the obstacle coming from the rear of the host vehicle at the time of right/left turn at the intersection, which is defined as the problem in the beginning of this specification, the prediction recognition information is used to shorten the period for specifying the avoidance target, so that it is possible to secure the control margin time of the avoidance control with respect to the obstacle coming from the rear and perform the collision avoidance control.

As described above, the vehicle control device 100 of the present embodiment includes: the external environment recognition unit 101 that acquires external environment information at least in front of a host vehicle; the control unit 102 that controls the host vehicle based on the external environment information acquired by the external environment recognition unit 101; and the storage unit 106 that stores detection information of a moving object acquired (detected) by the external environment recognition unit 101 when the host vehicle overtakes the moving object. The external environment recognition unit 101 reads past detection information of the moving object stored in the storage unit 106 when a course change of the host vehicle is predicted, determines a possibility of collision between the host vehicle and the moving object, sets, as prediction recognition information, (predicted detection timing and predicted detection region) of a moving object having a high possibility of colliding with the host vehicle at the course change of the host vehicle, based on the possibility of the collision (obstacle prediction recognition unit 105), and determines whether or not detection information of a moving object detected by the external environment recognition unit when the host vehicle changes a course is the same as past detection information of the moving object included in the prediction recognition information (recognition unit 104).

In a case where it is determined that the detection information of the moving object detected by the external environment recognition unit 101 when the host vehicle changes the course is the same as the past detection information of the moving object included in the prediction recognition information, the vehicle control device 100 specifies the moving object as the avoidance target with a shortened period for specifying an avoidance target of collision avoidance control, and shifts to the avoidance control or alarm with respect to the moving object (recognition unit 104).

The prediction recognition information includes a predicted detection timing and a predicted detection region of the moving object, and in at least a part of the external environment information of the host vehicle acquired by the external environment recognition unit 101, the vehicle control device 100 sets a predicted detection region (obtained by predicting a detection region) in which the moving object is predicted to be detected by the external environment recognition unit 101 when the host vehicle changes the course and sets a predicted detection timing (obtained by predicting a detection timing) in which the moving object is predicted to be detected by the external environment recognition unit 101 when the host vehicle changes the course, and determines whether or not the detection information of the moving object detected by the external environment recognition unit 101 when the host vehicle changes the course is the same as the past detection information of the moving object, based on conditions of the predicted detection timing and the predicted detection region (recognition unit 104).

The vehicle control device 100 determines the possibility of collision by comparing an intersection arrival time of the host vehicle with an intersection arrival time of the moving object calculated based on the past detection information of the moving object (obstacle prediction recognition unit 105).

In a case where it is determined that the detection information of the moving object detected by the external environment recognition unit 101 when the host vehicle changes the course is the same as the past detection information of the moving object included in the prediction recognition information, the vehicle control device 100 shortens a tracking processing time for specifying an avoidance target of collision avoidance control and specifies the moving object as the avoidance target (recognition unit 104).

The vehicle control device 100 sets the predicted detection region in a part of an image captured by a camera sensor that images at least a front of the host vehicle (recognition unit 104).

The vehicle control device 100 sets a reliability with respect to the prediction recognition information, based on a time when the moving object is detected and detection accuracy (weather condition or the like), and uses the reliability to determine consistency (identity) between the detection information and the past detection information.

In other words, the vehicle control device 100 according to the present embodiment includes the control unit 102 that performs collision avoidance control for avoiding a collision between an object in front of a host vehicle and the host vehicle, the external environment recognition unit 101 that performs obstacle recognition, the storage unit 106 that stores obstacle recognition information, the obstacle prediction recognition unit 105 that calculates a distance of the host vehicle to an intersection and an intersection arrival time, determines a possibility that the host vehicle collides at the time of right/left turn at the intersection with respect to each piece of the obstacle information stored in the storage unit 106, and generates prediction recognition information, and the prediction region setting unit that specifies an obstacle having a high possibility of collision when the host vehicle turns left at the intersection, based on the prediction recognition information and sets a region predicted to be detected. If an obstacle is detected in a prediction region set by the prediction region setting unit when the host vehicle turns left at the intersection, the vehicle control device 100 determines that a moving object stored in the past is re-detected, so as to shorten a time for specifying an avoidance target for which avoidance control is performed, thereby securing a control margin time necessary for the avoidance control.

That is, in the vehicle control device 100 according to the present embodiment, a means and a device are provided in which recognition information is stored when overtaking a two-wheeled vehicle, the recognition information of the two-wheeled vehicle recognized in the past is read at the time of right/left turn at an intersection to determine a possibility of collision with the host vehicle and calculate prediction recognition information, when the obstacle is actually detected at the left turn of the host vehicle, it is immediately confirmed by using the prediction recognition information that the obstacle is re-detection of a moving object recognized in the past, and avoidance control is performed.

According to the present invention, when the host vehicle travels on a road in front of an intersection, with total three operations which are (1) the operation in which recognition information of a moving object such as a bicycle is stored when overtaking the moving object at the time of traveling in front of an intersection, so that when the host vehicle is predicted to turn left at the intersection, the recognition information stored in the past is read to determine a possibility of collision between the host vehicle and the moving object stored in the past, (2) the operation in which the information of the moving object specified as having a high collision possibility as a result of determining the possibility of collision is used to calculate, as prediction recognition information, a detection timing and a detection region in which the moving object is predicted to be detected in the sensor detection range of the host vehicle when the host vehicle turns left, and a region in which the moving object is predicted to be detected is set in the sensor detection region at least in front of the host vehicle, and (3) the operation in which in a case where the object is detected at the predicted detection timing or in the detection region when the host vehicle turns left at the intersection, it is determined that the moving object stored in the past is re-detected, so as to shorten a period for specifying an avoidance target for which avoidance control is performed, thereby securing a control margin time necessary for the avoidance control, as for the securing of the margin time of the avoidance control with respect to the obstacle coming from the rear of the host vehicle at the time of right/left turn at the intersection, which is the current problem, the prediction recognition information is used to shorten the period for specifying the avoidance target, so that it is possible to secure the control margin time of the avoidance control with respect to the obstacle coming from the rear and perform the collision avoidance control.

According to the present embodiment, it is possible to realize prevention of, for example, a caught-in accident of a two-wheeled vehicle at the time of right/left turn at an intersection, which has been difficult to cope with conventionally.

Note that the embodiments described above are merely examples, and the present invention is not limited to these contents as long as the features of the invention are not impaired. Although various embodiments have been described above, the present invention is not limited to these contents. Other aspects conceivable within the scope of the technical idea of the present invention are also included within the scope of the present invention.

In addition, the present invention is not limited to the above-described embodiments, and includes various modifications. For example, the above-described embodiments have been described in detail for easy understanding of the present invention, and are not necessarily limited to those having all the described configurations. In addition, some or all of the above-described configurations, functions, processing units, processing means, and the like may be achieved by hardware, for example, by designing with an integrated circuit. In addition, each of the above-described configurations, functions, and the like may be achieved by software by a processor interpreting and executing a program for achieving each function. Information such as a program, a table, and a file for achieving each function can be stored in a storage device such as a memory, a hard disk, and a solid state drive (SSD), or a recording medium such as an IC card, an SD card, and a DVD.

### REFERENCE SIGNS LIST

1 general road including intersection
2 traffic light
3 host vehicle
4 sensor detection region
5 storage unit
6 two-wheeled vehicle
7 image generated by image processing unit
8 prediction region
50 host vehicle
51 sensor detection region
52 bicycle
53 bicycle
54 period for specifying avoidance target
55 general road with intersection
100 vehicle control device
101 external environment recognition unit
102 control unit
103 image processing unit
104 recognition unit
105 obstacle prediction recognition unit
106 storage unit
110 prediction region setting unit
111 moving object detection unit
112 prediction region detection determination unit
113 tracking processing unit
114 intersection distance calculation unit
115 intersection arrival time calculation unit
116 collision possibility determination unit
117 prediction reliability setting unit
120 right/left turn determination unit
121 collision risk calculation unit
122 route planning unit
123 control instruction unit
124 braking force/driving force control ECU
125 yaw rate sensor
126 imaging unit
127 steering angle sensor
128 alarm instruction unit
129 map information
130 direction indicator
131 communication network

1. A vehicle control device comprising:
an external environment recognition unit that acquires external environment information at least in front of a host vehicle;
a control unit that controls the host vehicle based on the external environment information acquired by the external environment recognition unit; and
a storage unit that stores detection information of a moving object acquired by the external environment recognition unit when the host vehicle overtakes the moving object, wherein
the external environment recognition unit reads past detection information of the moving object stored in the storage unit when a course change of the host vehicle is predicted, determines a possibility of collision between the host vehicle and the moving object, sets, as prediction recognition information, a moving object having a high possibility of colliding with the host vehicle at the course change of the host vehicle, based on the possibility of the collision, and determines whether or not detection information of a moving object detected by the external environment recognition unit when the host vehicle changes a course is same as past detection information of the moving object included in the prediction recognition information.

2. The vehicle control device according to claim 1, wherein in a case where it is determined that the detection information of the moving object detected by the external environment recognition unit when the host vehicle changes the course is same as the past detection information of the moving object included in the prediction recognition information, the vehicle control device specifies the moving object as the avoidance target with a shortened period for specifying an avoidance target of collision avoidance control, and shifts to the avoidance control or alarm with respect to the moving object.

3. The vehicle control device according to claim 1, wherein the prediction recognition information includes a predicted detection timing and a predicted detection region of the moving object, and
in at least a part of the external environment information of the host vehicle acquired by the external environment recognition unit, the vehicle control device sets a predicted detection region in which the moving object is predicted to be detected by the external environment recognition unit when the host vehicle changes the course and sets a predicted detection timing in which the moving object is predicted to be detected by the external environment recognition unit when the host vehicle changes the course, and determines whether or not the detection information of the moving object detected by the external environment recognition unit when the host vehicle changes the course is same as the past detection information of the moving object, based on conditions of the predicted detection timing and the predicted detection region.

4. The vehicle control device according to claim 1, wherein the vehicle control device determines the possibility of collision by comparing an intersection arrival time of the host vehicle with an intersection arrival time of the moving object calculated based on the past detection information of the moving object.

5. The vehicle control device according to claim 1, wherein in a case where it is determined that the detection information of the moving object detected by the external environment recognition unit when the host vehicle changes the course is same as the past detection information of the moving object included in the prediction recognition information, the vehicle control device shortens a tracking processing time for specifying an avoidance target of collision avoidance control and specifies the moving object as the avoidance target.

6. The vehicle control device according to claim 3, wherein the vehicle control device sets the predicted detection region in a part of an image captured by a camera sensor that images at least a front of the host vehicle.

7. The vehicle control device according to claim 1, wherein the vehicle control device performs the collision possibility determination as needed until the host vehicle reaches an intersection.

8. The vehicle control device according to claim 3, wherein in a case where the moving object included in the prediction recognition information is not detected in the predicted detection region even after the predicted detection timing, the vehicle control device deletes the prediction recognition information from the storage unit.

9. The vehicle control device according to claim 1, wherein the vehicle control device sets a reliability with respect to the prediction recognition information, based on a time when the moving object is detected and detection accuracy, and uses the reliability to determine consistency between the detection information and the past detection information.

10. The vehicle control device according to claim 1, wherein the vehicle control device reads the past detection information, as a trigger of reading the past detection information, when a travel route of the host vehicle is calculated based on map information and it is determined that a possibility of turning right/left at an intersection is high.

11. The vehicle control device according to claim 1, wherein the vehicle control device reads the past detection information, as a trigger of reading the past detection information, when it is determined based on an intersection recognition result by the external environment recognition unit that a possibility of turning right/left at an intersection is high.

12. The vehicle control device according to claim 1, wherein the vehicle control device reads the past detection information, as a trigger of reading the past detection information, when intersection information acquired by road-to-vehicle communication is used and it is determined that a possibility of turning right/left at an intersection is high.

13. The vehicle control device according to claim 3, wherein in a case where it is determined that the detection information of the moving object detected by the external environment recognition unit when the host vehicle changes the course is not same as the past detection information of the moving object included in the prediction recognition information, the vehicle control device cancels setting of the predicted detection region.
